(19) United States
(12) Patent Application Publication
(10) Pub. No.: US 2026/0079412 A1
(43) Pub. Date: Mar. 19, 2026

(54) ELECTROPHOTOGRAPHIC BELT AND ELECTROPHOTOGRAPHIC IMAGE FORMING APPARATUS

(71) Applicant: CANON KABUSHIKI KAISHA, Tokyo (JP)

(72) Inventors: HIROOMI KOJIMA, Kanagawa (JP); YASUTOMO TSUJI, Saitama (JP)

(21) Appl. No.: 19/321,565

(22) Filed: Sep. 8, 2025

(30) Foreign Application Priority Data
Sep. 18, 2024 (JP) 2024-161359

(51) Int. Cl. G03G 5/043; G03G 5/06; G03G 5/10

(52) U.S. Cl. CPC G03G 5/0436; G03G 5/0601; G03G 5/104; G03G 2215/2051; G03G 2215/2054

(57) ABSTRACT

An electrophotographic belt has a surface layer, wherein the surface layer includes a (meth)acrylic resin, a porous-spherical particle, and an electroconductive particle different from the porous-spherical particle; in an outermost surface of the surface layer, a surface of the porous-spherical particle is coated with the (meth)acrylic resin and the electroconductive particle; the ten-point average roughness Rz (according to JIS B 0601-1994) of the outermost surface of the surface layer is 0.5 times or larger and smaller than 2 times an average primary particle diameter of the porous-spherical particles; and an average spacing between local peaks S (according to JIS B 0601-1994) on the outermost surface of the surface layer is 4 times or larger and smaller than 30 times the average primary particle diameter of the porous-spherical particles.

### BACKGROUND

### Field of the Technology

The present disclosure relates to an electrophotographic belt and an electrophotographic image forming apparatus including the electrophotographic belt.

### Description of the Related Art

In an electrophotographic image forming apparatus, an electrophotographic belt having an endless shape is used as a conveying transfer belt for conveying a transfer material, or an intermediate transfer belt for temporarily transferring and holding a toner image. The surface layer of the electrophotographic belt is required to have a surface resistivity in a medium resistance region, which is uniform in the plane, in order to efficiently perform primary transfer and secondary transfer of toner images.

In addition, the electrophotographic belt is in contact with and slides on other members in the electrophotographic image forming apparatus, and in a case where the surface of the electrophotographic belt is excessively smooth, the electrophotographic belt adheres to other members, in some cases. For example, when a photosensitive drum or a cleaning blade has adhered to the surface of the electrophotographic belt, stable rotation of the electrophotographic belt is hindered, in some cases.

If the stability of the rotation of the electrophotographic belt decreases, for example, a moving speed of the electrophotographic belt becomes unstable, and a shift (color shift) occurs when the toner images of the respective colors are transferred to paper, in some cases. Then, in order to prevent the adhesion of other members to the surface of the electrophotographic belt, it has been conventionally conducted to form unevenness on the surface of the electrophotographic belt.

As a method for forming the unevenness on the surface of the electrophotographic belt, Japanese Patent Laid-Open No. 2020-148996 proposes such a method that the outermost surface layer includes a matrix resin and particles having an average particle diameter of 0.5 μm or larger and 20 μm or smaller and having hardness higher than that of the matrix resin, and that a part of the particles is exposed to the outside in the outermost surface layer to roughen the surface.

The belt disclosed in Japanese Patent Laid-Open No. 2020-148996 includes the particles having the average particle diameter of 0.5 to 20 μm and having a higher hardness than the matrix resin, and a part of the particles is exposed to the outside; and accordingly, when the belt is used as the electrophotographic belt, forms unevenness on the surface, and can reduce an adhesive force to a photosensitive drum. Because of this, even when multi-color characters are printed, the amount of toner color shift is small, and a satisfactory image quality can be obtained.

However, in the case of the belt according to Japanese Patent Laid-Open No. 2020-148996, when a solid image is printed, local omission of the toner (transfer blurring) has been often observed. The transfer blurring means such an image defect that when an image having a uniform density is output, some toners are not transferred in some places, and in-plane uniformity of an image decreases.

### SUMMARY

Then, according to at least one aspect of the present disclosure, there is provided such an electrophotographic belt that the amount of the toner color shift is small and the amount of transfer blurring is little. In addition, at least one aspect of the present disclosure is directed to providing an electrophotographic image forming apparatus that can form high-quality electrophotographic images.

At least one aspect of the present disclosure is an electrophotographic belt having a surface layer, wherein the surface layer includes a (meth)acrylic resin, a porous-spherical particle, and an electroconductive particle different from the porous-spherical particle; in an outermost surface of the surface layer, a surface of the porous-spherical particle is coated with the (meth)acrylic resin and the electroconductive particle; the ten-point average roughness Rz (according to JIS B 0601-1994) of the outermost surface of the surface layer is 0.5 times or larger and smaller than 2 times an average primary particle diameter of the porous-spherical particle; and an average spacing between local peaks S (according to JIS B 0601-1994) on the outermost surface of the surface layer is 4 times or larger and smaller than 30 times the average primary particle diameter of the porous-spherical particle.

In addition, at least one aspect of the present disclosure is an electrophotographic image forming apparatus including the electrophotographic belt as an intermediate transfer belt.

Features of the present disclosure will become apparent from the following description of embodiments with reference to the attached drawings. The following description of embodiments is described by way of example.

### BRIEF DESCRIPTION OF THE DRAWINGS

FIG. 1A shows a schematic view illustrating a configuration of a surface of an electrophotographic belt based on the present disclosure, and FIG. 1B shows a cross-sectional view taken along the line A-A′ of FIG. 1A.

FIG. 2 shows a schematic cross-sectional view of an injection molding apparatus which has been used in Example.

FIG. 3A, FIG. 3B, FIG. 3C and FIG. 3D show schematic cross-sectional views of a primary blow-molding apparatus which has been used in Example.

FIG. 4 shows a schematic cross-sectional view of a secondary blow-molding apparatus which has been used in Example.

FIG. 5 is a schematic sectional view illustrating an example of a full-color electrophotographic image forming apparatus using an electrophotographic process.

FIG. 6 shows a schematic view of a jig for evaluating adhesiveness between the electrophotographic belt and another member.

### DESCRIPTION OF THE EMBODIMENTS

In the present disclosure, the description of “XX or larger and YY or smaller” and “XX to YY”, which represent a numerical range, means a numerical range including a lower limit and an upper limit which are end points, unless otherwise specified. In addition, in the case where numerical ranges are described in stages, the upper limit and the lower limit of each numerical range can be combined freely. In addition, in the present disclosure, for example, a description such as “at least one selected from the group consisting of XX, YY and ZZ” means any one of XX, YY and ZZ, a combination of XX and YY, a combination of XX and ZZ, a combination of YY and ZZ, and a combination of XX, YY and ZZ.

### One Embodiment

One embodiment relates to an electrophotographic belt.

The electrophotographic belt of the present disclosure is an electrophotographic belt having a surface layer, wherein the surface layer includes a (meth)acrylic resin, a porous-spherical particle, and an electroconductive particle different from the porous-spherical particle; in an outermost surface of the surface layer, a surface of the porous-spherical particle is coated with the (meth)acrylic resin and the electroconductive particle; the ten-point average roughness Rz (according to JIS B 0601-1994) of the outermost surface of the surface layer is 0.5 times or larger and smaller than 2 times an average primary particle diameter of the porous-spherical particles; and an average spacing between local peaks S (according to JIS B 0601-1994) on the outermost surface of the surface layer is 4 times or larger and smaller than 30 times the average primary particle diameter of the porous-spherical particles.

The transfer blurring means such an image defect that when an image having a uniform density is output, some toners are not transferred in some places, and in-plane uniformity of an image decreases.

It is considered that the transfer blurring occurs at a portion at which a distribution of the electroconductive particles for adjusting the surface resistivity of the electrophotographic belt is irregular and the resistance becomes locally high. Specifically, it is presumed that in the belt, there is a portion at which the particle contained for forming the unevenness is exposed to the surface, and the electroconductive particle does not exist in the portion.

Based on such a consideration, the present inventors have repeated studies to obtain an electrophotographic belt in which the distribution irregularity of the electroconductive particles is small, while the electrophotographic belt contains spherical particles in the outermost surface layer thereof and thereby forms the unevenness. As a result, the present inventors have found that an electrophotographic belt can be obtained which has unevenness formed on the surface and has small irregularity of surface resistivity, by using a (meth)acrylic resin as a matrix resin of the surface layer and containing a porous-spherical particle and an electroconductive particle.

The present inventors presume the reason why the irregularity of the surface resistivity can be reduced through the unevenness formed on the surface, in the electrophotographic belt having the above configuration, in the following way.

In order to form unevenness on the surface of the electrophotographic belt, it is more preferable that the surface layer is a thin film with respect to a particle diameter of a spherical particle contained in the surface layer. However, in this case, the spherical particle cannot be sufficiently coated with the (meth)acrylic resin, and a part of the spherical particles is exposed on the surface, in some cases. The electroconductive particles contained in the surface layer exist in a form of being dispersed in the (meth)acrylic resin, and accordingly, it is difficult for the electroconductive particle to exist on the spherical particle exposed on the surface.

In addition, in a case where the surface layer is formed as a film having a sufficiently large thickness with respect to the particle diameter of the spherical particle included in the surface layer, the spherical particle can be coated with the (meth)acrylic resin and the electroconductive particle, but it is difficult to form sufficient unevenness.

In contrast to this, due to blending of the porous-spherical particle in the surface layer, even when the surface layer has been made thinner than the particle diameter of the porous-spherical particle, it becomes easy for the (meth)acrylic resin to adsorb to the porous-spherical particle, and accordingly, the porous-spherical particle can be coated with the (meth)acrylic resin; and furthermore, it becomes easy for the electroconductive particles dispersed in the (meth)acrylic resin also to exist on the porous-spherical particle, and a state can be formed in which the electroconductive particles are uniformly distributed over the whole region of the surface of the electrophotographic belt.

As a result, it is considered that the unevenness is formed on the surface of the electrophotographic belt, the electroconductive particles are uniformly distributed while the amount of toner color shift is reduced which is caused by the adhesion between the belt and the photosensitive drum, and as a result, the transfer blurring can be improved.

The electrophotographic belt according to one aspect of the present disclosure will be described below in detail. Note that the present disclosure is not limited to the following aspects.

### <<Electrophotographic Belt>>

The electrophotographic belt according to the present disclosure has a surface layer.

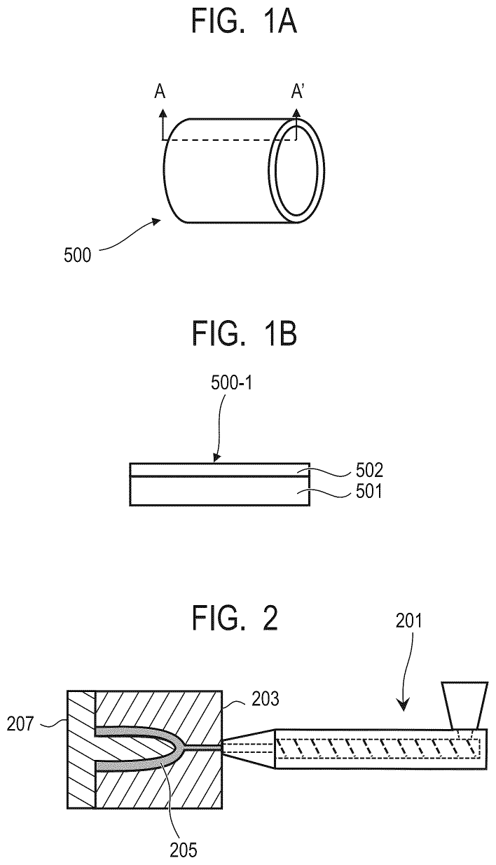

FIG. 1A illustrates a perspective view of an electrophotographic belt 500 having an endless belt shape according to one aspect of the present disclosure. Examples of the layer configuration include such a laminated structure in a cross section taken along the line A-A′ in FIG. 1A including a base layer 501 and a surface layer 502 which covers an outer peripheral face of the base layer, as is illustrated in FIG. 1B. In a case where the surface layer 502 is provided, the outer surface 500-1 of the surface layer 502 serves as a toner carrying surface of the electrophotographic belt. In addition, the electrophotographic belt may have a layer other than the base layer and the surface layer.

### <Base Layer>

The base layer is formed from a resin composition (or also referred to as a thermoplastic resin composition) which contains a crystalline polyester serving as a binder and an ion conductive agent. A thickness of the base layer according to the present disclosure is not particularly limited. However, the electrophotographic belt is arranged in a bent state in the electrophotographic image forming apparatus, and accordingly, it is preferable to set the thickness of the base layer to 40 μm or larger and 500 μm or smaller, and particularly to 50 μm or larger and 100 μm or smaller, from the viewpoint of ensuring flexibility.

### (Crystalline Polyester)

The crystalline polyester can be obtained by polycondensation of a dicarboxylic acid and a diol, polycondensation of an oxycarboxylic acid or a lactone, or polycondensation with the use of a plurality of these components. Further polyfunctional monomers may be used in combination. The crystalline polyester may be a homopolyester containing one type of ester bond, or may be a copolyester (copolymer) containing a plurality of ester bonds.

Suitable examples of the crystalline polyester include at least one selected from the group consisting of a polyalkylene terephthalate and a polyalkylene naphthalate which have high crystallinity and exhibit excellent heat resistance. In addition, copolymers with a polyalkylene naphthalate and a polyalkylene isophthalate can be suitably used.

The number of carbon atoms of the alkylene in the polyalkylene terephthalate, the polyalkylene naphthalate and the polyalkylene isophthalate is preferably 2 or more and 16 or less, from the viewpoint of high crystallinity and heat resistance. More specifically, as the crystalline polyester, polyethylene terephthalate (PET), polyethylene naphthalate (PEN), polyethylene isophthalate, and a copolymer including these components are preferable. These materials may be used singly, or also in combination of two or more types thereof.

A molecular weight of the crystalline polyester is not particularly limited, but for example, in the case of PET, the preferable weight average molecular weight is 50000 (fifty thousand) or larger and 80000 (eighty thousand) or smaller. In addition, in the case of PEN, the preferable weight average molecular weight is 20000 (twenty thousand) or larger and 80000 (eighty thousand) or smaller.

A content ratio of the crystalline polyester in the base layer is preferably 50.0% by mass or more, and is more preferably 60.0% by mass or more, with respect to a total mass of the thermoplastic resin composition. When the content ratio of the crystalline polyester is within the above range, a mechanical strength of the base layer can be more reliably enhanced.

### (Ion Conductive Agent)

The base layer may contain a low-molecular type of ion conductive agent as an electroconductive agent for adjusting the resistivity. For example, a low-molecular type of ion conductive agent includes an ionic liquid. The ionic liquid refers to a salt which is formed of an anion and a cation, and exhibits a melting point at a temperature of 100° C. or lower. Specific examples of the ion conductive agent include lithium bis(trifluoromethanesulfonyl)imide and lithium bis(fluorosulfonyl)imide, which are classified as the ionic liquid.

In a case where the base layer contains the ion conductive agent, a content ratio of the ion conductive agent is not particularly limited, but is preferably set, for example, to 0.5% by mass or more and 8.0% by mass or less, based on the mass of the base layer.

### (Additive Agent)

Other components may be added to the thermoplastic resin composition in such a range that the effects of the present disclosure are not impaired. Examples of the other components include a filler, an antioxidant, an ultraviolet absorber, an organic pigment, an inorganic pigment, a pH adjuster, a crosslinking agent, a compatibilizer, a mold release agent, a coupling agent and a lubricant. These additive agents may be used singly, or also in combination of two or more types thereof. The amount of the additive agent to be used can be appropriately set, and is not particularly limited.

### <Surface Layer>

The electrophotographic belt has the surface layer on the outer peripheral face of the base layer, for the purpose of preventing a decrease in the adhesive force to a contact member such as a photosensitive drum or a cleaning blade, blocking, and the like. In the electrophotographic belt according to the present disclosure, the surface layer includes a (meth)acrylic resin as a binder, a porous-spherical particle, and an electroconductive particle different from the porous-spherical particle.

In the electrophotographic belt according to the present disclosure, the thickness of the surface layer is preferably equal to or smaller than the average primary particle diameter of the porous-spherical particles, and is, for example, preferably 1 μm or larger and 5 μm or smaller. By doing in this way, such an electrophotographic belt can be obtained that the amount of toner color shift is smaller and the transfer blurring is less.

### ((Meth)Acrylic Resin)

It is preferable that a resin to be used in the surface layer contains at least a (meth)acrylic resin as a curable composition, because the (meth)acrylic resin is excellent in the scratch resistance to the outer surface of the surface layer. For information, a content of the (meth)acrylic resin in the surface layer is preferably 60.0% by mass or more and 85.0% by mass or less, and more preferably 65.0% by mass or more and 80.0% by mass or less, based on the mass of the surface layer.

### (Electroconductive Particle)

In the electrophotographic belt according to the present disclosure, the electroconductive particle is preferably an electroconductive metal oxide. When the electrophotographic belt is used as the intermediate transfer belt, for example, the surface layer is required to have semiconductivity. Because of this, it is preferable to use the electroconductive particle such as the electroconductive metal oxide as a particle which imparts electroconductivity. The fact that the electroconductive particle is the electroconductive metal oxide can be confirmed by observation with an FE-SEM and measurement with EDX for the electroconductive particle.

In the electrophotographic belt according to the present disclosure, the average primary particle diameter of the electroconductive particles (the number average particle diameter of the primary particles of the electroconductive particles) is preferably 0.01 μm or larger and 0.04 μm or smaller, and is more preferably 0.01 μm or larger and 0.025 μm or smaller. Due to the number average particle diameter of the electroconductive particles being set within the above range, a singular point (spot) can be prevented from forming on the outer surface of the surface layer.

In addition, a dispersion state in the curable composition (liquid state) can be stabilized, and even in a case where the curable composition has been stored for a long period of time and then has been subjected to the formation of the surface layer, c the surface layer having the outer surface in which the electroconductive particles are stably dispersed can be provided. The electroconductive particle may be surface-treated in order to enhance the dispersion stability in an organic solvent. In addition, the electroconductive metal oxide particle may be used in combination of two or more types of particles.

The electroconductive particle preferably includes at least one particle selected from the group consisting of a zinc antimonate particle and an antimony-containing tin oxide particle. Commercially available products of the electroconductive metal-oxide particle, which can be used, include: Celnax (registered trade name) CX-Z410K (trade name) produced by Nissan Chemical Industries Ltd.; CELNAX (registered trade name) CX-Z400K (trade name) produced by Nissan Chemical Industries, Ltd.; and SN-100P (trade name) produced by Ishihara Sangyo Kaisha, Ltd.

### (Porous-Spherical Particle)

The porous-spherical particle contained in the surface layer is a micron-sized particle which is added for the purpose of controlling the surface unevenness of the electrophotographic belt and the distribution of the electroconductive particles. The porous-spherical particles have various chemical structures, crystal structures, and crystallinity, and have characteristics also in a shape and a size depending on a production method.

Examples of the porous-spherical particle to be used in the present disclosure include: a silica particle, a silicone particle, activated carbon, zeolite, and a fine particle of a thermosetting resin. These materials may be used singly or in combination of two or more types thereof.

In the electrophotographic belt according to the present disclosure, a surface of the porous-spherical particle is coated with the (meth)acrylic resin and the electroconductive particle, in the outermost surface of the surface layer. This can be confirmed by observation with an FE-SEM and measurement with EDX, for the surface and the cross section of the surface layer.

The shape and size are not particularly limited, but a size capable of forming the unevenness on the surface and to be spherical is preferred. This is because when the particle which forms the unevenness is spherical, isotropy tends to be easily obtained with respect to a dispersion state and an orientation state, and the unevenness can also be easily formed on the surface, as compared with an amorphous particle or a fibrous material, regardless of a manufacturing method of the electrophotographic belt.

In the electrophotographic belt according to the present disclosure, the average primary particle diameter of the porous-spherical particles is preferably 1.0 μm or larger and 10 μm or smaller, more preferably 2.5 μm or larger and 5 μm or smaller, and further preferably 2.9 μm or larger and 4.9 μm or smaller.

This is because when the characteristics of the porous-spherical particle are as described above, the (meth)acrylic resin containing the electroconductive particle tends to easily adhere to the porous-spherical particle by an anchor effect, and it becomes easy to control the dispersion of the electroconductive particles. By doing in this way, the surface of the porous-spherical particle can be coated with the (meth)acrylic resin and the electroconductive particle.

In the electrophotographic belt according to the present disclosure, it is preferable that the porous-spherical particle is a porous-spherical silica particle or a porous-spherical silicone particle, from such viewpoints that the particles are excellent in thermal stability, have low surface energy, cause less coagulation among particles and are easy to control dispersion. Whether the porous-spherical particle is the porous-spherical silica particle or the porous spherical silicone particle can be confirmed by observation with an FE-SEM and measurement with EDX for the porous-spherical particle.

The average primary particle diameter of the porous-spherical particles can be measured according to the following method. For example, a measurement sample is cut out of which the length is 5 mm, the width is 5 mm, and the thickness corresponds to the entire thickness of the electrophotographic belt, from arbitrary 20 portions of the electrophotographic belt.

A part of the cross section of each of the obtained measurement samples is further cut out with a microtome or the like, and is observed with an FE-SEM (trade name: Sigma 500VP, manufactured by Carl Zeiss Microscopy) at a magnification of 5000 times, and a photograph is obtained. In addition, at the same time, an elemental analysis is performed with the use of EDX (Energy Dispersive X-ray Spectroscopy), and elements contained in the porous-spherical particles are identified. Furthermore, from the obtained photograph, the diameters of the porous-spherical particle in the belt thickness direction and in the direction perpendicular to the belt thickness direction are measured, and the average value thereof is defined as the particle diameter of the porous-spherical particle.

The particle diameter is measured in the same way for each of at least 50 porous-spherical particles, and the average value of the particle diameters of the top 10 particles can be taken as the average primary particle diameter of the porous-spherical particles.

In addition, there are pores on the surface and inside of the porous-spherical particle, and it is considered that the number and size of the pores correlate with the capability of adsorbing other substances. As an index of the capability of adsorbing other substances, the DBP oil absorption is exemplified; and in the electrophotographic belt according to the present disclosure, the DBP oil absorption of the porous-spherical particle is preferably 100 mL/100 g or more and 200 mL/100 g or less, and more preferably 142 mL/100 g or more and 160 mL/100 g or less. By doing in this way, such an electrophotographic belt can be obtained that the amount of the toner color shift is smaller and the transfer blurring is less.

### (Others)

In the electrophotographic belt according to the present disclosure, the ten-point average roughness Rz (according to JIS B 0601-1994) of the outermost surface of the surface layer is 0.5 times or larger and smaller than 2 times the average primary particle diameter of the porous-spherical particles, and is preferably 0.7 times or larger and 1.7 times or smaller of the average primary particle diameter of the porous-spherical particles. By doing in this way, such an electrophotographic belt can be obtained that the amount of the toner color shift is smaller and the transfer blurring is less.

In the electrophotographic belt according to the present disclosure, the average spacing between local peaks S (according to JIS B 0601-1994) on the outermost surface of the surface layer is 4 times or larger and smaller than 30 times the average primary particle diameter of the porous-spherical particles, is preferably 6 times or larger and 22 times or smaller of the average primary particle diameter of the porous-spherical particles, and is more preferably 6.6 times or larger and 21.7 times or smaller of the average primary particle diameter of the porous-spherical particles. By doing in this way, such an electrophotographic belt can be obtained that the amount of the toner color shift is smaller and the transfer blurring is less.

### <<Method for Manufacturing Electrophotographic Belt>>

### <Method of Manufacturing Base Layer>

The cylindrical film base layer can be manufactured, for example, through the following steps (i) to (iii).

Step (i): obtaining a preform that is formed from a resin mixture containing a crystalline polyester and an ion conductive agent, and has a test tube shape.

Step (ii): stretching the preform in the longitudinal direction, also biaxially stretch-forming the preform in the longitudinal direction and the circumferential direction by introducing a gas into the preform, and obtaining a formed product (hereinafter, also referred to as “bottle”) (biaxial stretch blow forming).

Next, step (iii): cutting both ends of the bottle and obtaining a cylindrical film having an endless shape.

Regarding the step (i), a pellet is prepared by hot-melt kneading of the resin mixture which contains the crystalline polyester and the ion conductive agent. In the hot-melt kneading of the thermoplastic resin composition, kneading at the following temperature is preferred. Specifically, kneading at a temperature higher than a melting point of the crystalline polyester to be contained in the resin mixture is preferred. The kneading method is not particularly limited, and a single-screw extruder, a twin-screw kneading extruder, a Banbury mixer, a roll, Brabender, plastograph, a kneader or the like can be used.

A preform having a test tube shape is molded with the use of the thus obtained resin mixture. The method for molding the preform is not particularly limited, and examples thereof include the following methods. As illustrated in FIG. 2, one method is a method of molding a preform 205 having a predetermined shape, by injecting a molten material of the resin mixture into a mold for molding the preform, which includes a cavity mold 203 and a core mold 207, with the use of an injection molding apparatus 201, and solidifying the molten material in the mold for molding the preform.

For information, at this time, it is preferable to set a temperature of the mold for molding the preform, into which the molten material is injected, to 40° C. or lower, for example. The molten material injected into the mold is cooled and solidified in the mold, and rapid cooling at this time can prevent crystallization of the crystalline polyester from proceeding.

Due to the crystallization of the crystalline polyester being suppressed in the preform, the crystal orientation of the crystalline polyester in the biaxial directions can be more accurately controlled in the stretch blow forming in the step (ii).

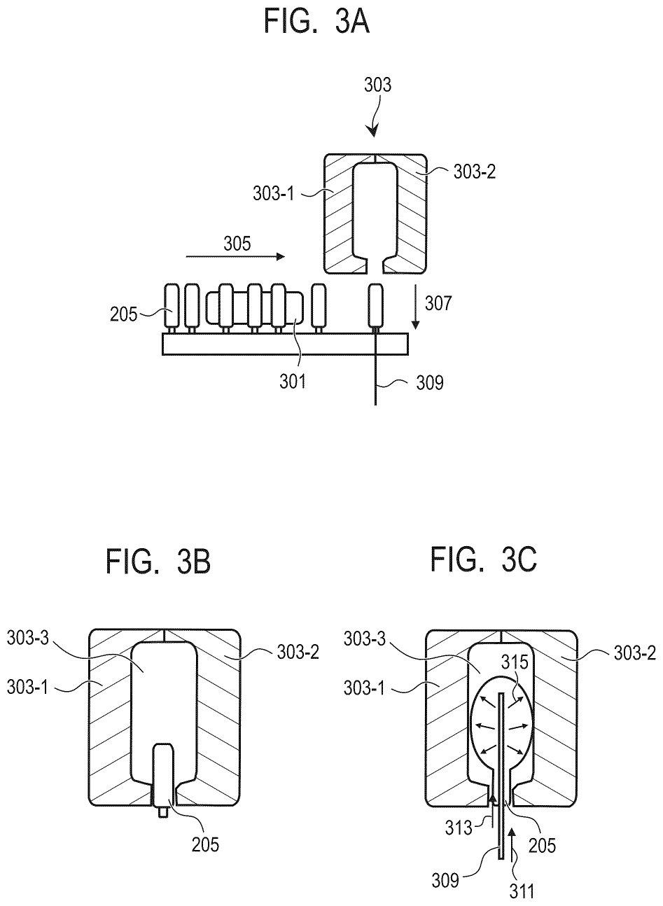

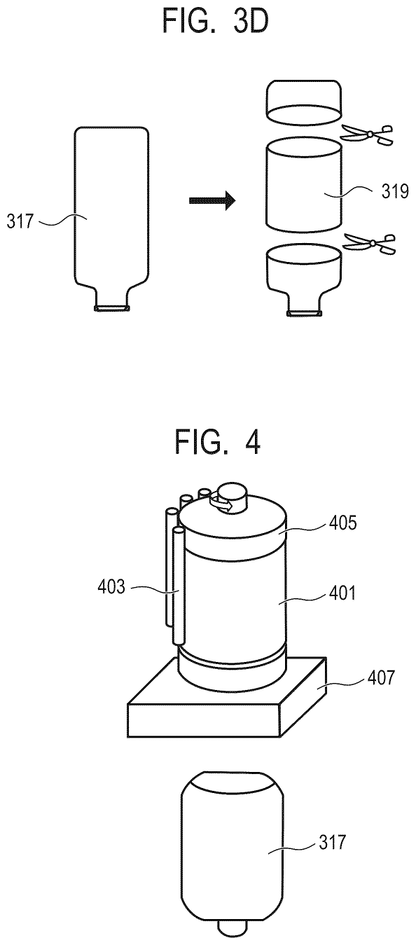

Next, in the step (ii), the preform is subjected to biaxial stretch blow forming. Firstly, as is illustrated in FIG. 3A, the preform 205 is placed in a heating furnace 301 and heated to a temperature at which stretching is possible. A heating time period at this time is preferably within 1 minute. Due to the heating time period being set to 5 minutes or shorter, it can be prevented that the crystallization of the crystalline polyester proceeds in the preform during heating. A heated preform is conveyed in the direction of the arrow 305.

Next, a blow die 303 in which the cylindrical cavity 303-3 is formed in the inside by the combination of a left side die 303-1 and a right side die 303-2 is lowered in the direction of the arrow 307 from directly above the heated preform 205. Then, as is illustrated in FIG. 3B, the preform is arranged at a mouth portion of the blow die 303.

For information, it is preferable to place the heated preform at the mouth portion of the blow die in a short time (for example, within 20 seconds) so that the temperature of the heated preform does not drop before the start of the next biaxial stretching step. Thereby, it can be prevented that the crystallization of the crystalline polyester in the preform proceeds due to slow cooling of the preform. For information, it is acceptable to calculate a heating temperature of the preform previously by checking an endothermic peak at the time of temperature rise or the shift of a base line, with the use of a differential scanning calorimeter (DSC) of the resin mixture which is a constituent material of the preform, or to determine the heating temperature from the glass transition temperature (Tg).

As is illustrated in FIG. 3C, a stretching rod 309 is driven in the direction of the arrow 311, and thereby stretches the heated preform 205 which has been placed in the blow die 303, in the longitudinal direction of the preform 205. This stretching is referred to as primary stretching. In addition, in synchronization with the driving of the stretching rod 309, a gas is caused to flow into the preform from a mouth portion of the preform 205 (arrow 313), and expands the preform in its circumferential direction. This operation is referred to as secondary stretching.

Examples of the gas to be blown include air, nitrogen, carbon dioxide and argon. As a result, the preform 205 expands in each direction indicated by the arrows 315 in FIG. 3C, adheres to the inner wall of the cavity 303-3, and is cooled and solidified in the state. Next, the left side die 303-1 and the right side die 303-2 of the blow die 303 are separated, and thereby, a formed product having a bottle shape (hereinafter, also referred to as “blow bottle”) is taken out from the blow die 303.

Next, as is illustrated in FIG. 3D, portions of the obtained blow bottle 317 are cut down which are on the mouth portion side and on an upper end opposite to the mouth portion side, and a biaxially stretched cylindrical film 319 is obtained which becomes the base layer.

For information, it is also acceptable to subject the blow bottle 317 to heat treatment before cutting as needed, and to adjust the surface roughness of the outer peripheral face of the blow bottle, or finely adjust crystallinity of the crystalline polyester. Examples of the specific method include: as illustrated in FIG. 4, placing the blow bottle 317 in a cylindrical die 401, and then filling the blow bottle with a gas; and then, setting the upper portion and the lower portion of the die 401 in a state in which outer dies are respectively mounted thereon, in order that the gas in the inner part of the blow bottle does not leak out, and heating the die 401 while rotating the die 401 by a roller-shaped heater 403 which is brought in contact with the outer peripheral face of the die 401. The heating temperature is set, for example, about 130 to 190° C., and the heating time period is set, for example, about 60 seconds so that the whole circumference of the blow bottle is uniformly heated.

The application of the electrophotographic belt according to the present disclosure is not limited to the intermediate transfer belt, and the electrophotographic belt is also suitably used, for example, as a conveying transfer belt and the like.

### <Method for Producing Surface Layer>

The method for producing the surface layer is not particularly limited, but it is preferable to include a step of applying a curable composition to the above described base layer, curing the curable composition, and obtaining a surface layer.

[Step 1] A step of preparing the curable composition containing the following component (a) to component (d).

The method for producing the curable composition is not particularly limited, but the curable composition contains the porous-spherical particle, the electroconductive particle, and the (meth)acrylic monomer which often has a high viscosity, and accordingly, it is preferable to produce the curable composition in the following way. A slurry in which porous-spherical particles are dispersed in a solvent, a slurry in which electroconductive particles are dispersed in a solvent, and a solution in which the (meth)acrylic monomer component is dissolved in a solvent are prepared in advance. Then, these components, a polymerization initiator and another component are placed in a container equipped with a stirrer, in a blend which will be described later, and the mixture is stirred, for example, at room temperature for 30 minutes; and the curable composition can be obtained. Concentrations of the slurry and the solution can be set within a range that allows easy stirring. The total amount of the solvent is, for example, 200 parts by mass or more and 2000 parts by mass or less, and preferably 500 parts by mass or more and 1200 parts by mass or less, with respect to 100 parts by mass of the total of the (meth)acrylic monomer, the porous-spherical particle and the electroconductive particle.

### ((Meth)Acrylic Monomer)

It is preferable that the curable composition to be used for forming the surface layer contains a monomer which forms the (meth)acrylic resin, for example, a (meth)acrylic monomer.

The (meth)acrylic monomer is not particularly limited, but a polyfunctional (meth)acrylic monomer is preferable from the viewpoint of rubbing resistance and hardness; and preferable examples thereof include pentaerythritol tri(meth)acrylate, pentaerythritol tetra(meth)acrylate, trimethylolpropane tri(meth)acrylate, ethylene oxide-modified trimethylolpropane tri(meth)acrylate, propylene oxide-modified trimethylolpropane tri(meth)acrylate, dipentaerythritol penta- and hexa(meth)acrylates, and isocyanuric acid ethylene oxide-modified di- and tri(meth)acrylates. It is particularly preferable that the acrylic monomer includes dipentaerythritol penta- and hexa(meth)acrylates. In addition, a plurality of acrylic monomers can be used for the adjustment of curing shrinkage and viscosity.

In addition, for example, a commercially available product can be used such as ARONIX (registered trademark) M-305 (trade name) of Toagosei Co., Ltd.

### (Solvent)

It is preferable that the curable composition contains a solvent, from such a viewpoint that the solvent stably disperses or dissolves the (meth)acrylic monomer, the electroconductive particle and the porous-spherical particle which have been previously described. It is preferable that the solvent contains at least one selected from the group consisting of 2-butanone and 4-methyl-2-pentanone.

In addition, a plurality of solvents other than the above can also be added for adjustments of an evaporation rate and the viscosity. Specific examples include alcohols such as methanol, ethanol, isopropanol, butanol and octanol; ketones such as acetone and cyclohexanone; esters such as ethyl acetate, butyl acetate, ethyl lactate, γ-butyrolactone, propylene glycol monomethyl ether acetate, and propylene glycol monoethyl ether acetate; ethers such as ethylene glycol monomethyl ether and diethylene glycol monobutyl ether; aromatic hydrocarbons such as benzene, toluene and xylene; and amides such as dimethylformamide, dimethylacetamide and N-methylpyrrolidone.

Among these, methyl isobutyl ketone, methyl ethyl ketone, cyclohexanone, propylene glycol monomethyl ether acetate, propylene glycol monoethyl ether acetate, toluene, xylene and the like are preferable.

### (Radical Polymerization Initiator)

Examples of the radical polymerization initiator include a compound that thermally generates an active radical species (thermal polymerization initiator) and a compound that generates an active radical species by irradiation with radiation (light) (radiation (photo) polymerization initiator).

The radiation (photo) polymerization initiator is not particularly limited as long as the initiator is decomposed by light irradiation, generates a radical and initiates polymerization; and examples thereof include acetophenone, acetophenone benzyl ketal, 1-hydroxycyclohexyl phenyl ketone, 2,2-dimethoxy-1,2-diphenylethane-1-one, xanthone, fluorenone, benzaldehyde, fluorene, anthraquinone, triphenylamine, carbazole, 3-methylacetophenone, 4-chlorobenzophenone, 4,4′-dimethoxybenzophenone, 4,4′-diaminobenzophenone, benzoin propyl ether, benzoin ethyl ether, benzyl dimethyl ketal, 1-(4-isopropylphenyl)-2-hydroxy-2-methylpropane-1-one, 2-hydroxy-2-methyl-1-phenylpropane-1-one, thioxanthone, diethylthioxanthone, 2-isopropylthioxanthone, 2-chlorothioxanthone, 2-methyl-1-[4-(methylthio)phenyl]-2-morpholino-propane-1-one, 2-benzyl-2-dimethylamino-1-(4-morpholinophenyl)butanone-1, 4-(2-hydroxyethoxy)phenyl-(2-hydroxy-2-propyl)ketone, 2,4,6-trimethylbenzoyldiphenyl phosphine oxide, bis-(2,6-dimethoxybenzoyl)-2,4,4-trimethylpentyl phosphine oxide, and oligo(2-hydroxy-2-methyl-1-(4-(1-methylvinyl)phenyl)propanone).

The blending amount of the radical polymerization initiator is preferably 0.01 parts by mass or more and 10 parts by mass or less, and more preferably 0.1 parts by mass or more and 5 parts by mass or less, with respect to 100 parts by mass of the (meth)acrylic monomer component. When the blending amount is 0.01 parts by mass or more, sufficient hardness of the cured material is obtained, and when the amount is 10 parts by mass or less, the obtained cured product can be sufficiently cured to the inner part (lower layer).

### (Other Components)

Other components can be added to the curable composition as needed, within a range which does not hinder the effects of the present disclosure. For example, a dispersant, a polymerization inhibitor, a polymerization initiation aid, a leveling agent, a wettability improving agent, a surface-active agent, a plasticizer, an ultraviolet absorbing agent, an antioxidizing agent, an antistatic agent, an inorganic filler, a pigment and the like can be blended.

[Step 2] A step of forming a coating film of the curable composition on one surface of the base layer, and drying the coating film; and a step of curing the dried coating film.

A coating film of the curable composition is formed on the surface of the base layer, for example, by procedures of fitting the base layer to the outer periphery of a cylindrical mold, sealing the end portion, immersing the whole mold in a container which is filled with the curable composition, and pulling up the mold so that the relative speed between the liquid surface of the curable composition and the base layer is constant. The pulling-up speed (relative speed between the liquid surface of the curable composition and the base layer), a solvent ratio in the curable composition and the like may be adjusted according to a required film thickness.

For example, the pulling-up speed can be set to 10 mm/sec or larger and 50 mm/sec or smaller.

After the coating film has been formed, the coating film is dried and cured. In the step of drying the coating film, a drying temperature, humidity, and a drying time may be appropriately adjusted according to the type of solvent, the solvent ratio, the film thickness and the like. It is preferable that the drying temperature is, for example, 20° C. or higher and 30° C. or lower. It is preferable that the relative humidity during drying is 40% or higher and 70% or lower. In addition, it is preferable that the drying time is 30 seconds or longer and 300 seconds or shorter. Within the above range, the coating film can be reliably dried, and a decrease in the degree of curing can be suppressed, which is caused by the solvent remaining in the cured film during curing.

After that, the dried coating film is cured, and a surface layer is obtained. For example, curing by UV irradiation is possible. The integrated light amount can be appropriately set according to a material to be used. The integrated light amount can be set, for example, to 300 mJ/cm² or more and 2000 mJ/cm² or less.

The content of the porous-spherical particle in the surface layer is preferably 0.5% by mass or more and 20.0% by mass or less, and more preferably 1.0% by mass or more and 15.0% by mass or less, based on the mass of the surface layer. When the content is within the above range, the porous-spherical particle can form the unevenness on the surface, and can be coated with the (meth)acrylic resin. By doing in this way, the surface of the porous-spherical particle can be coated with the (meth)acrylic resin and the electroconductive particle. In addition, the content of the electroconductive particle in the surface layer can be adjusted within a range in which a desired resistance value is obtained.

### <Electrophotographic Image Forming Apparatus>

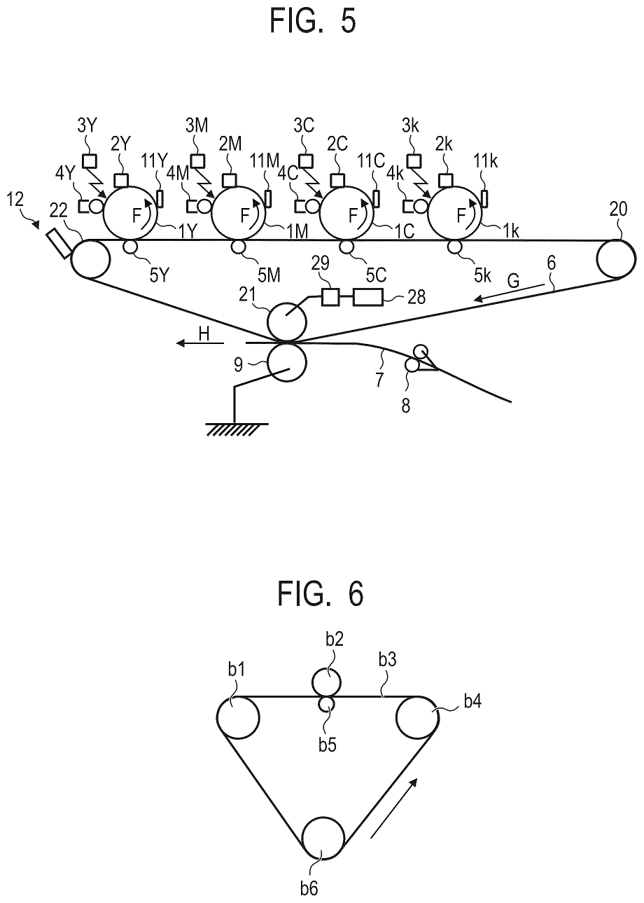

The electrophotographic image forming apparatus of the present disclosure includes the electrophotographic belt of the present disclosure as an intermediate transfer belt. An example of the electrophotographic image forming apparatus will be described below which has used the electrophotographic belt according to one aspect of the present disclosure, as the intermediate transfer belt. As illustrated in FIG. 5, the electrophotographic image forming apparatus has a so-called tandem type of configuration in which electrophotographic stations of a plurality of colors are arranged in a rotation direction of the intermediate transfer belt. For information, in the following description, suffixes Y, M, C and k are added to the reference numerals of the configurations related to the colors of yellow, magenta, cyan and black, respectively, but the suffix is omitted for the same configuration, in some cases.

In FIG. 5, around the photosensitive drums (photosensitive members and image bearing members) 1Y, 1M, 1C and 1k, there are arranged charging apparatuses 2Y, 2M, 2C and 2k, exposure apparatuses 3Y, 3M, 3C and 3k, developing apparatuses 4Y, 4M, 4C and 4k, and an intermediate transfer belt (intermediate transfer body) 6. The photosensitive drum 1 is rotationally driven at a predetermined peripheral speed (process speed) in the direction of the arrow F (counterclockwise direction). The charging apparatus 2 charges the peripheral surface of the photosensitive drum 1 to predetermined polarity and potential (primary charging).

A laser beam scanner serving as the exposure apparatus 3 outputs laser light which has been on/off modulated so as to correspond to image information that is input from an external apparatus such as an unillustrated image scanner and an unillustrated computer, and scans and exposes the charged surface on the photosensitive drum 1 with light. By this scanning exposure, an electrostatic latent image corresponding to target image information is formed on the surface of the photosensitive drum 1.

The developing apparatuses 4Y, 4M, 4C and 4k contain toners of respective color components of yellow (Y), magenta (M), cyan (C) and black (k), respectively. Then, the developing apparatuses 4 to be used are selected based on the image information, a developer (toner) is developed on the surface of the photosensitive drum 1, and the electrostatic latent image is visualized as a toner image. In the present embodiment, a reverse development system is used which attaches the toner to the exposed portion of the electrostatic latent image in this way and develops the electrostatic latent image. In addition, the charging apparatus, the exposure apparatus and the developing apparatus constitute an electrophotographic image forming unit, in this way.

In addition, the intermediate transfer belt 6 includes an electrophotographic belt having an endless shape. In addition, the intermediate transfer belt 6 is stretched by a plurality of rollers 20, 21 and 22 so that the outer peripheral face of the intermediate transfer belt 6 comes in contact with the surfaces of the photosensitive drums 1. In the present embodiment, the roller 20 is a tension roller structured to control the tension of the intermediate transfer belt 6 so as to be constant; the roller 22 is a driving roller of the intermediate transfer belt 6; and the roller 21 is a counter roller for secondary transfer. Then, the intermediate transfer belt 6 rotates in the direction of the arrow G by the drive of the roller 22. In addition, primary transfer rollers 5Y, 5M, 5C and 5k are arranged on primary transfer positions which face the photosensitive drums 1, respectively, while sandwiching the intermediate transfer belt 6 therebetween.

Unfixed toner images of the colors, which have been formed on the photosensitive drums 1, respectively, are sequentially and electrostatically primary-transferred onto the intermediate transfer belt 6, by a primary transfer bias having a polarity opposite to the charging polarity of the toner, which is applied to the primary transfer rollers 5 by a constant voltage source or a constant current source, any of which is not illustrated. Then, a full-color image is obtained in which unfixed toner images of four colors are superimposed on the intermediate transfer belt 6. The intermediate transfer belt 6 rotates while carrying the toner images which have been transferred thereonto from the photosensitive drums 1, in this way. At every one rotation of the photosensitive drums 1 after the primary transfer, the transfer residual toners on the surfaces of the photosensitive drums 1 are cleaned by cleaning apparatuses 11 (11Y, 11M, 11C and 11k), respectively, and the resultant surfaces repeatedly enter the image forming step.

In addition, at the secondary transfer position of the intermediate transfer belt 6, which faces the conveyance path of the recording material 7 serving as the transfer medium, a secondary transfer roller (transfer portion) 9 is press-contacted and arranged at the toner image carrying surface side of the intermediate transfer belt 6. In addition, on the back surface side of the intermediate transfer belt 6 at the secondary transfer position, there is disposed the counter roller 21 which forms a counter electrode of the secondary transfer roller 9 and to which a bias is applied.

When the toner image on the intermediate transfer belt 6 is transferred to the recording material 7, a bias, for example, −3000 V or higher and −1000 V or lower having the same polarity as that of the toner is applied to the counter roller 21 by a transfer bias application unit 28, and a current of −50 μA or higher and −10 μA or lower flows through the counter roller 21. A transfer voltage at this time is detected by a transfer voltage detecting unit 29. Furthermore, a cleaning apparatus (blade cleaner) 12 for removing the toner which remains on the intermediate transfer belt 6 after the secondary transfer is provided on the downstream side of the secondary transfer position.

The recording material 7 passes through a conveyance guide 8, is conveyed in a direction of the arrow H, and is introduced into a secondary transfer position. The recording material 7 which has been introduced into the secondary transfer position is nipped at the secondary transfer position and is conveyed; and at that time, a constant voltage bias (transfer bias) that is controlled to a predetermined value is applied to the counter roller 21 of the secondary transfer roller 9 from the secondary transfer bias application unit 28. Due to the transfer bias having the same polarity as that of the toner, which has been applied to the counter roller 21, a full-color image (toner image) of four colors that are superposed on the intermediate transfer belt 6 is transferred to the recording material 7 at the transfer portion at a time, and a full-color unfixed toner image is formed on the recording material. The recording material 7 on which the toner image has been transferred is introduced into an unillustrated fixing apparatus, and is heated there; and the toner image is fixed by heating.

### EXAMPLES

The present disclosure will be specifically described below with reference to Examples and Comparative Examples, but the present disclosure is not limited thereto. Materials used for manufacturing electrophotographic belts according to Examples and Comparative Examples are shown below.

TABLE 1

| Brevity | |
|---|---|
| code | Material name (product name and the like) |
| Crystalline | Polyethylene naphthalate |
| polyester (PES) | (product name: TN-8050SC, produced by Teijin Limited) |
| Ion conductive | N,N,N-tributyl-N-methylammonium-bis(trifluoromethane |
| agent (IC) | sulfonyl)imide |
| | (product name: FC-4400, produced by 3M Japan |
| | Limited.) |

TABLE 2

| Brevity | |
|---|---|
| code | Material name (product name and the like) |
| AN | Dipentaerythritol penta- and hexa-acrylate |
| | (product name: Aronix M-402, produced by Toagosei Co., |
| | Ltd.) |
| Particle 1 | Porous-spherical silica particles, average primary particle |
| (Fi1) | diameter 3.0 μm |
| | (product name: Sunsphere H31, manufactured by AGC |
| | Si-Tech Co., Ltd.) |
| Particle 2 | Porous-spherical silica particles, average primary particle |
| (Fi2) | diameter 5.0 μm |
| | (product name: Sunsphere H53, manufactured by AGC |
| | Si-Tech Co., Ltd.) |
| Particle 3 | Spherical-silicone particles, average primary particle |
| (Fi3) | diameter 3.0 μm |
| | (product name: Tospearl 130, manufactured by Momentive |
| | Performance Materials Japan) |
| SL | Zinc antimonate particle slurry |
| | (product name: Celnax CX-Z400K, produced by Nissan |
| | Chemical Corporation, and 40% by mass as zinc antimonate |
| | particle component) |
| IRG | Photopolymerization initiator |
| | (product name: Irgacure 907, produced by BASF) |

### (Methods for Measuring and Evaluating Characteristic Values)

The measurement methods and evaluation methods of the characteristic values of the electrophotographic belts according to Examples and Comparative Examples are as described in the following [Evaluation 1] to [Evaluation 6].

### [Evaluation 1] Evaluation of DBP Oil Absorption (DBP Absorbed Amount) of Porous-Spherical Particle

The DBP oil absorption of the porous-spherical particle contained in the produced electrophotographic belt was measured according to the following method. One hundred sample pieces of 2 mm×2 mm were cut out from the electrophotographic belt, a pulverized product thereof was left to stand in a high-temperature tank at a temperature of 350° C. for 48 hours, thereby the resin component was burned out, and the remaining porous-spherical particles were extracted.

The DBP oil absorption of the extracted porous-spherical particles was measured with the use of an absorption tester (trade name: S-500; manufactured by ASAHISOUKEN CORPORATION). Specifically, 10 g of the collected porous-spherical particles were placed in a measurement chamber, and the torque was measured by setting the drip rate of DBP (dibutyl phthalate) to 4 mL/min and the number of rotations of a rotor to 125 rpm. The DBP absorbed amount can be defined by the DBP dropping amount and the sample amount at which the torque becomes 70% of the peak torque value.

For information, when the porous-spherical particles in an amount necessary for the measurement of the DBP oil absorption cannot be obtained from 100 sample pieces, the necessary amount of the porous-spherical particles may be obtained by increasing the number of samples to be collected, and carrying out the above operation.

### [Evaluation 2] Evaluation of the Ten-Point Average Roughness Rz and the Average Spacing Between Local Peaks S of the Electrophotographic Belt Surface

The roughness of the electrophotographic belt was measured according to the following method. The roughness index was determined according to JIS B 0601-1994. A surface-roughness measuring instrument (trade name: Surfcom 1500SD, manufactured by Tokyo Seimitsu Co., Ltd.) was used as a measuring apparatus. The roughness was measured under the conditions of a cut-off wavelength of 0.25 mm, a measuring length of 1.25 mm, and a feeding speed of a measuring probe of 0.2 mm/sec, as measurement parameters.

Here, the ten-point average roughness Rz and the average spacing between local peaks S of the surface of the electrophotographic belt were obtained by scanning a measurement probe of a measurement apparatus in a direction orthogonal to the circumferential direction of the electrophotographic belt, measuring 8 points of 2 points in the width direction×4 points in the circumferential direction, for each one belt of the electrophotographic belts which were arbitrarily extracted, and calculating an average value thereof.

[Evaluation 3] Evaluation of Coating of Porous-Spherical Particle with (Meth)Acrylic Resin

Whether or not the porous-spherical particle was coated with the (meth)acrylic resin was determined according to the following method. Firstly, a measurement sample was cut out of which the length was 5 mm, the width was 5 mm, and the thickness corresponded to the whole thickness of the electrophotographic belt, from arbitrary 20 portions of the obtained electrophotographic belt.

A part of the cross section of each of the obtained measurement samples was further cut out with a microtome or the like, and the cross section was observed with an FE-SEM (trade name: Sigma 500VP, manufactured by Carl Zeiss Microscopy) at a magnification of 10000 times; and it was visually confirmed from the obtained photograph whether a coating layer existed on the outer surface of the porous-spherical particle.

In addition, at the same time, an elemental analysis was performed with the use of EDX (Energy Dispersive X-ray Spectroscopy), and it was confirmed whether or not the elemental component of the electroconductive particle was detected on the outer surface of the porous-spherical particle. The above evaluation was carried out for each of at least 50 porous-spherical particles.

### [Evaluation 4] Evaluation of Rank of Transfer Blurring

The transfer blurring means such an image defect that when an image having a uniform density is output, some toners are not transferred in some places, and in-plane uniformity of an image decreases.

A full-color electrophotographic apparatus (trade name: LBP 672C, manufactured by CANON KABUSHIKI KAISHA) was used, and a cyan cartridge was filled with 150 g of a toner to be evaluated, and the whole toner cartridge was left to stand under an environment of a high temperature and a high humidity (30° C./80% RH) for 24 hours.

The toner cartridge after having been left to stand for 24 hours and the electrophotographic belt were attached to the full-color electrophotographic apparatus, and an image having a printing ratio of 1.0% was printed out on 1,000 sheets of A4 paper in the lateral direction. After the 1,000 sheets were printed, a solid image with a toner loading amount of 0.40 mg/cm² was printed on CS-680 (basis weight: 68 g/m², sold by Canon Marketing Japan Inc.).

The image was visually observed, and the transfer blurring was evaluated based on the following criteria. For information, in the present disclosure, a portion at which the image uniformity was impaired was determined as transfer blurring.

S: the transfer blurring is not observed under normal light or even when the printed paper is held up to strong light.

A: the transfer blurring is hardly observed, under normal light and even when the printed paper is held up to strong light.

B: the transfer blurring is not observed under normal light, but the transfer blurring is observed when the printed paper is held up to strong light.

C: The transfer blurring is observed even under normal light.

Here, the normal light refers to a state at the time when light from a general fluorescent lamp is applied to the front surface, and the strong light refers to a state at the time when light from the general fluorescent lamp was applied from both sides of the front surface and the back surface. In the present disclosure, A or higher was determined to have little transfer blurring.

[Evaluation 5] Evaluation of Adhesiveness with Photosensitive Drum

The adhesiveness with the photosensitive drum of a full-color electrophotographic apparatus (trade name: LBP-672C, manufactured by CANON KABUSHIKI KAISHA) was measured with the use of a jig as in FIG. 6. An electrophotographic belt b3 is tensioned by a driving roller b1 which is equipped with a motor and a torque meter, a driven roller b4, and a tension roller b6 which applies tension to the electrophotographic belt b3. A photosensitive drum and a transfer roller of an LBP-672C are used for a photosensitive drum b2 and a backup roller b5, respectively.

The electrophotographic belt is rotated at 180 mm/sec in a state in which the photosensitive drum is not in contact with the electrophotographic belt, and a torque value at this time is measured. This value is referred to as “Tq1”. Next, the photosensitive drum is brought into contact with the electrophotographic belt at 700 gf while the electrophotographic belt is rotated at 180 mm/sec, and the maximum value of the torque at this time is measured. This value is referred to as “Tq2”.

Then, the difference between the “Tq2” and the “Tq1” was used as an index for evaluating the adhesiveness between the electrophotographic belt and the photosensitive drum. In addition, when the difference was smaller than 0.10 Nm, the evaluation rank was determined as “A”, and when the difference was 0.10 Nm or larger, the evaluation rank was determined as “B”.

In addition, when the electrophotographic belt and the photosensitive drum are brought into contact with each other, the photosensitive drum is fixed without being rotated, and the contact surface of the photosensitive drum is always set to a new state.

### [Evaluation 6] Evaluation of Color Shift Amount of Toner

An electrophotographic belt was attached to a full-color electrophotographic apparatus (trade name: LBP-672C, manufactured by CANON KABUSHIKI KAISHA), and a blue character image and a blue line image which use developers of cyan and magenta, and a green character image and a green line image which use developers of cyan and yellow were output on plain paper of an A3 size (trade name: GF-C081A3, manufactured by CANON KABUSHIKI KAISHA), under an environment of a high temperature and a high humidity (temperature of 30° C. and relative humidity of 80%). Then, the obtained image was observed with a microscope, and the color shift amount of the image was measured.

### Example 1

### (Production of Base Layer)

A pre-blended sample was obtained by mixing of a crystalline polyester and an ion conductive agent in Table 1 at a ratio of crystalline polyester/ion conductive agent=96/4 (weight ratio), and was hot-melt kneaded with the use of a twin-screw extruder (trade name: TEX30a, manufactured by Japan Steel Works, Ltd.); and thereby, a thermoplastic resin composition was prepared. The hot-melt kneading temperature was adjusted so as to be in a range of 270° C. or higher and 320° C. or lower, and the hot-melt kneading time was set to 3 to 5 minutes. The obtained thermoplastic resin composition was pelletized and dried at a temperature of 140° C. for 10 hours.

Next, the obtained thermoplastic resin composition was charged into an injection-molding apparatus (trade name: SE180D, manufactured by Sumitomo Heavy Industries, Ltd.); and was injection-molded into a mold of a test tube shape, of which the temperature was adjusted to 30° C., while the cylinder temperature was set to 270 to 320° C.; and a preform was produced. The obtained preform had a shape like a test tube of which the outside diameter was 50 mm, the inside diameter was 46 mm, the length was 150 mm, and the thickness was 2 mm.

Next, the above preform was stretched in biaxial directions of the longitudinal direction and the circumferential direction, with the use of a biaxial stretch forming apparatus. Firstly, as illustrated in FIG. 3A, the preform 205 was placed in a heating furnace 301 which was equipped with a non-contact type of heater (unillustrated) for heating the preform 205, and was heated by the heater so that the outer surface temperature of the preform became 120 to 160° C.

Next, the blow die 303 in which the die temperature was kept at 30° C. was lowered toward the heated preform 205 in the direction of the arrow 307, and the heated preform 205 was arranged in a mouth portion of the blow die 303 (FIG. 3B). Next, as illustrated in FIG. 3C, the stretching rod 309 was driven in the direction of the arrow 311, and simultaneously with the start of driving of the stretching rod, air of which the temperature was adjusted to 23° C. was introduced into the inside from the mouth portion of the preform 205 as indicated by the arrow 313 in FIG. 3C. In this way, the preform 205 was stretched in the biaxial directions, and was brought into close contact with the inner wall of the blow die. For information, a driving speed of the stretching rod 309 was set to 2.0 m/sec, and a pressure of air introduced into the inside of the blow bottle was set to 0.5 MPa.

Next, the left side die 303-1 and the right side die 303-2 of the blow die 303 were separated, and thereby, a formed product (blow bottle) 317 having a bottle shape was taken out from the blow die 303.

Next, the obtained blow bottle 317 was set in the cylindrical die 401 which was illustrated in FIG. 4, set on a base 407, produced by an electroforming method and made from nickel, and an outer die 405 was attached thereto. An air pressure of 0.1 MPa was applied to the inside of the blow bottle to adjust the air so as not to leak to the outside, and thereby, the outer peripheral face of the blow bottle 317 was brought into close contact with the inner peripheral surface of the cylindrical die. Furthermore, the whole circumference of the blow bottle was uniformly heat-treated at 130 to 190° C. for 60 seconds with the use of the heater 403, while the cylindrical die 401 made from nickel was rotated at 2 rotations/second at a constant speed.

After that, air having a temperature of 25° C. was blown onto the cylindrical die made from nickel to cool the cylindrical die down to room temperature (25° C.), and the pressure of the air was released, which was applied to the inside of the blow bottle 317, and the blow bottle 317 was obtained of which the dimension was improved by the annealing. As for the biaxial stretching magnification based on the dimensions of the preform 205 and the blow bottle 317, the transverse stretching magnification (circumferential direction) Lp was 4.0 times, and the longitudinal stretching magnification (direction orthogonal to the circumferential direction) La was 3.8 times.

Next, as illustrated in FIG. 3D, the portion of the blow bottle 317 on the mouth portion side and the portion opposite to the mouth portion side were cut, and a base layer of the electrophotographic belt was produced, of which the peripheral length was 628 mm, the width was 250 mm, and the thickness was 70 μm.

(Preparation of curable composition)

Materials for the surface layer described in Table 2 were weighed at a ratio of AN/Fi1/SL/IRG=74.0/5.0/20.0/1.0 (mass ratio in terms of solid content), and a solution in which the materials except SL were subjected to a coarse dispersion treatment was dispersed with the use of a high-pressure emulsification dispersing apparatus (trade name: Nanovater, manufactured by Yoshida Kikai Co., Ltd.). The main dispersion treatment was carried out until the 50% average particle size of the contained Fil reached 3 μm. The obtained dispersion liquid (curable composition) was used as a coating liquid for the surface layer.

### (Formation of Surface Layer)

The base layer is fitted on an outer periphery of a cylindrical die (peripheral length of 628 mm), and the end portion thereof is sealed; and then, the resultant die is immersed in a container filled with the coating liquid for the surface layer, and is pulled up so that a relative speed between the liquid surface of the coating liquid and the base layer of the electrophotographic belt becomes constant. In this way, a coating film which was formed from the curable composition was formed on the surface of the base layer of the electrophotographic belt. The pulling-up speed (relative speed between the liquid surface of the coating liquid and the base layer of the electrophotographic belt) and a solvent ratio of the curable composition can be adjusted according to a required film thickness of the surface layer.

In the present Example, the pulling-up speed was set to 20 mm/sec, and the film thickness of the surface layer was adjusted so as to become approximately 2.0 μm. In the present Example, an application direction refers to a direction opposite to a direction in which the base layer of the electrophotographic belt is pulled up. Specifically, the position which is firstly pulled up from the coating liquid becomes the most upstream position. The base layer of the electrophotographic belt, to which the coating liquid was applied, was removed from the cylindrical die, and was dried for 1 minute in an environment at 23° C., under exhaust ventilation. The drying temperature and drying time are appropriately adjusted according to a solvent type, the solvent ratio, and the film thickness.

After that, the coating film was irradiated with ultraviolet rays by use of a UV irradiation machine (trade name: UE06/81-3, manufactured by Eye Graphics Company) until the integrated light quantity reached 600 mJ/cm², and thereby the coating film was cured.

The thickness of the surface layer was measured by such a destructive test as to cut an electrophotographic belt which was separately produced under the same conditions and observe the cross section with an electron microscope (trade name: XL30-SFEG, manufactured by FEI Company Japan Ltd.).

As a result of the destructive test, the thickness of the surface layer was 1.8 μm. In this way, the electrophotographic belt was obtained that had a surface layer formed on the outer peripheral face of the base layer. The electrophotographic belt was subjected to the above (Evaluation 1) to (Evaluation 6).

### Examples 2 to 5

Electrophotographic belts were produced in the same way as in Example 1, except that the coating liquids were prepared according to the blending amounts described in Table 3, and were evaluated.

### Example 6

An electrophotographic belt was produced in the same way as in Example 1, except that the coating liquid was prepared according to the blending amount described in Table 3, the pulling-up speed was set to 30 mm/sec, and the thickness of the surface layer was increased; and was evaluated.

TABLE 3

| Material brevity | Example | | | | | |
|---|---|---|---|---|---|---|
| code | 1 | 2 | 3 | 4 | 5 | 6 |
| AN [mass %] | 74.0 | 69.0 | 64.0 | 74.2 | 63.7 | 69.0 |
| Fi1 [mass %] | 5.0 | 10.0 | 15.0 | 10.0 | 10.0 | 0.0 |
| Fi2 [mass %] | 0.0 | 0.0 | 0.0 | 0.0 | 0.0 | 10.0 |
| SL [mass %] | 20.0 | 20.0 | 20.0 | 15.0 | 25.0 | 20.0 |
| IRG [mass %] | 1.0 | 1.0 | 1.0 | 0.8 | 1.3 | 1.0 |
| Surface layer | 1.8 | 1.6 | 1.7 | 1.8 | 1.9 | 2.8 |
| thickness [um] | | | | | | |

### Comparative Examples 1 to 3

Electrophotographic belts were produced in the same way as in Example 1, except that the coating liquids were prepared according to the blending amounts described in Table 4, and were evaluated.

### Comparative Example 4

An electrophotographic belt was produced in the same way as in Example 1, except that the coating liquid was prepared according to the blending amount described in Table 4, the pulling-up speed was set to 40 mm/sec, and the thickness of the surface layer was increased; and was evaluated.

TABLE 4

| | |
|---|---|
| Material brevity | Comparative Example |

| code | 1 | 2 | 3 | 4 |
|---|---|---|---|---|
| AN [mass %] | 69.0 | 29.0 | 49.0 | 69.0 |
| Fi1 [mass %] | 0.0 | 50.0 | 0.0 | 10.0 |
| Fi3 [mass %] | 10.0 | 0.0 | 10.0 | 0.0 |
| SL [mass %] | 20.0 | 20.0 | 40.0 | 20.0 |
| IRG [mass %] | 1.0 | 1.0 | 1.0 | 1.0 |
| Surface layer | 1.8 | 2.0 | 1.9 | 3.8 |
| thickness [um] | | | | |

The evaluation results of the electrophotographic belts of Examples 1 to 6 are shown in Table 5. In addition, the evaluation results of the electrophotographic belts of Comparative Examples 1 to 4 are shown in Table 6.

TABLE 5

| | Example | | | | | |
|---|---|---|---|---|---|---|
| Evaluation item | 1 | 2 | 3 | 4 | 5 | 6 |
| DBP oil absorption of porous | 145 | 156 | 157 | 142 | 160 | 147 |
| particle [mL/100 g] | | | | | | |
| Average primary particle diameter | 3.1 | 3.2 | 2.9 | 4.9 | 3 | 3.3 |
| of porous-spherical particles [μm] | | | | | | |
| Average primary particle diameter | 0.035 | 0.031 | 0.038 | 0.032 | 0.035 | 0.036 |
| of electroconductive particles [μm] | | | | | | |
| Ten-point average roughness Rz [μm] | 2.4 | 3.1 | 4.2 | 3.2 | 3.5 | 5.6 |
| Ten-point average roughness Rz/ | 0.8 | 1 | 1.4 | 0.7 | 1.2 | 1.7 |
| average primary particle diameter | | | | | | |
| of porous-spherical particles | | | | | | |
| Average spacing between local | 67.3 | 34.7 | 19.1 | 40.6 | 37.4 | 57.9 |
| peaks S [μm] | | | | | | |
| Average spacing between local | 21.7 | 10.8 | 6.6 | 8.3 | 12.5 | 17.5 |
| peaks S/average primary particle | | | | | | |
| diameter of porous-spherical | | | | | | |
| particles | | | | | | |
| Is the porous particle coated? | ◯ | ◯ | ◯ | ◯ | ◯ | ◯ |
| Rank of transfer blurring | S | S | S | S | S | S |
| Is there adhesiveness with | A | A | A | A | A | A |
| photosensitive drum? | | | | | | |
| Color shift amount of toner [μm] | 64 | 56 | 50 | 55 | 67 | 61 |

TABLE 6

| | Comparative Example | | | |
|---|---|---|---|---|
| Evaluation item | 1 | 2 | 3 | 4 |
| DBP oil absorption of porous | 28 | 151 | 36 | 147 |
| particle [mL/100 g] | | | | |
| Average primary particle diameter | 3.2 | 3 | 2.9 | 3.1 |
| of porous-spherical particles [μm] | | | | |
| Average primary particle diameter | 0.034 | 0.033 | 0.036 | 0.031 |
| of electroconductive particles [μm] | | | | |
| Ten-point average roughness Rz | 2.6 | 0.7 | 2.8 | 0.2 |
| [μm] | | | | |
| Ten-point average roughness Rz/ | 0.8 | 0.2 | 1 | 0.1 |
| average primary particle diameter | | | | |
| of porous-spherical particles | | | | |
| Average spacing between local | 49.6 | 4.8 | 52.2 | 46.2 |
| peaks S [μm] | | | | |
| Average spacing between local | 15.5 | 1.6 | 18 | 14.9 |
| peaks S/average primary particle | | | | |
| diameter of porous-spherical | | | | |
| particles | | | | |
| Is the porous particle coated? | X | ◯ | X | ◯ |
| Rank of transfer blurring | C | A | C | A |
| Is there adhesiveness with | A | B | A | B |
| photosensitive drum? | | | | |
| Color shift amount of toner [μm] | 56 | 156 | 61 | 172 |

In Comparative Example 1, a non-porous particle is blended in place of the porous-spherical particle. Specifically, it is considered that the ratio is small at which the (meth)acrylic resin and the electroconductive particle exist on the outer surface of the spherical particle, a local high resistance portion is formed, and the transfer blurring became worse.

In Comparative Example 2, the porous-spherical particle was excessively blended, and thereby, the average spacing between local peaks S on the outermost surface became small. As a result, the surface unevenness became small, and the adhesive force with the photosensitive drum increased, and accordingly, it is considered that the amount of the toner color shift increased.

In Comparative Example 3, the non-porous particle was blended to increase the amount of the electroconductive particle. However, the non-porous particle could not be sufficiently coated with the (meth)acrylic resin, and the ratio of the electroconductive particle on the outer surface of the non-porous particle was small, and accordingly, it is considered that a local high resistance portion was formed, and the transfer blurring became worse.

In Comparative Example 4, the surface layer is thickened. Specifically, the porous-spherical particles are coated with the (meth)acrylic resin, and the electroconductive particles are uniformly distributed, but the surface unevenness became small; and accordingly, the adhesiveness with the photosensitive drum increased, and it is considered that the amount of the toner color shift increased.

According to at least one aspect of the present disclosure, such an electrophotographic belt can be obtained that the amount of the toner color shift is smaller and the transfer blurring is little. In addition, according to at least one aspect of the present disclosure, an electrophotographic image forming apparatus can be obtained that can form a high quality of the electrophotographic image.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-161359, filed Sep. 18, 2024, which is hereby incorporated by reference herein in its entirety.

What is claimed is:

1. An electrophotographic belt comprising a surface layer, wherein
the surface layer comprises a (meth)acrylic resin, a porous-spherical particle, and an electroconductive particle different from the porous-spherical particle;
in an outermost surface of the surface layer, a surface of the porous-spherical particle is coated with the (meth)acrylic resin and the electroconductive particle;
the ten-point average roughness Rz (according to JIS B 0601-1994) of the outermost surface of the surface layer is 0.5 times or larger and smaller than 2 times an average primary particle diameter of the porous-spherical particle; and
an average spacing between local peaks S (according to JIS B 0601-1994) on the outermost surface of the surface layer is 4 times or larger and smaller than 30 times the average primary particle diameter of the porous-spherical particle.

2. The electrophotographic belt according to claim 1, wherein the porous-spherical particle has an average primary particle diameter of 1.0 μm or larger and 10 μm or smaller.

3. The electrophotographic belt according to claim 1, wherein a DBP oil absorption of the porous-spherical particle is 100 mL/100 g or more and 200 mL/100 g or less.

4. The electrophotographic belt according to claim 1, wherein the porous-spherical particle is a porous-spherical silica particle or a porous-spherical silicone particle.

5. The electrophotographic belt according to claim 1, wherein the electroconductive particle has an average primary particle diameter of 0.01 μm or larger and 0.04 μm or smaller.

6. The electrophotographic belt according to claim 1, wherein the electroconductive particle is an electroconductive metal oxide.

7. The electrophotographic belt according to claim 1, wherein a thickness of the surface layer is equal to or smaller than an average primary particle diameter of the porous-spherical particle.

8. An electrophotographic image forming apparatus comprising an electrophotographic belt having a surface layer as an intermediate transfer belt, wherein
the surface layer comprises a (meth)acrylic resin, a porous-spherical particle, and an electroconductive particle different from the porous-spherical particle;
in an outermost surface of the surface layer, a surface of the porous-spherical particle is coated with the (meth)acrylic resin and the electroconductive particle;
the ten-point average roughness Rz (according to JIS B 0601-1994) of the outermost surface of the surface layer is 0.5 times or larger and smaller than 2 times an average primary particle diameter of the porous-spherical particle; and
an average spacing between local peaks S (according to JIS B 0601-1994) on the outermost surface of the surface layer is 4 times or larger and smaller than 30 times the average primary particle diameter of the porous-spherical particle.
